(19) United States
(12) Patent Application Publication
(10) Pub. No.: US 2021/0409403 A1
(43) Pub. Date: Dec. 30, 2021

(54) SERVICE TO SERVICE SSH WITH AUTHENTICATION AND SSH SESSION REAUTHENTICATION

(71) Applicant: Microsoft Technology Licensing, LLC, Redmond, WA (US)

(72) Inventors: Guy LEWIN, New York, NY (US); Vitaly KHAIT, Yavne (IL); Liran MOYSI, Kfar Saba (IL)

(21) Appl. No.: 16/912,299

(22) Filed: Jun. 25, 2020

(51) Int. Cl. H04L 29/06

(52) U.S. Cl. CPC H04L 63/0884; H04L 63/123

(57) ABSTRACT

Methods, systems and computer program products are provided for service to service SSH with authentication and SSH session reauthentication. A client service initiates an SSH session by automatically providing authentication information to an authentication provider service, which returns access information. The client service uses an SSH client to automatically provide the access information to an SSH server, which receives and validates the access information. A service-to-service SSH session is created between the SSH client and SSH server. The client service and a server service may communicate securely via the service-to-service SSH session. Security may be maintained for any type of SSH connection (e.g., user to service, service to service) by periodically and automatically providing and validating reauthentication and refresh information. AN SSH connection/session is maintained if periodic access information is validated. AN SSH connection/session is terminated if periodic access information is not provided in a refresh interval or is invalid.

### BACKGROUND

Secure Shell (SSH) is an application that may be used for secure remote connections and traffic tunneling. SSH may allow a user to establish an SSH connection (e.g., as an operating system user) based on manual authentication. An authenticated user may perform shell commands or port forwarding/tunneling over an SSH connection. SSH connections last forever for users, which may not be secure.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

Methods, systems and computer program products are provided for service to service SSH with authentication and SSH session reauthentication. A client service may initiate an SSH session, for example, by providing authentication information (e.g., OAuth client credentials) to an authentication provider service (e.g., an OAuth provider), which may return access information (e.g., an access token) for valid credentials. The client service may use an SSH client to provide the access information to an SSH server. The SSH server may receive and validate the access information. An SSH session between services (e.g., a service-to-service SSH session) may be created between the SSH client and SSH server. The client service and a server service may communicate securely via the service-to-service SSH session. Security may be maintained for any type of SSH connection (e.g., user to service, service to service), for example, by periodically and automatically providing, receiving and validating reauthentication and refresh information. Any type of SSH connection/session may be maintained, for example, if periodic reauthentication/access information is periodically provided and validated. Any type of SSH connection/session may be terminated, for example, if periodic reauthentication/access information is not provided in a time interval or is invalid.

Further features and advantages of the invention, as well as the structure and operation of various embodiments, are described in detail below with reference to the accompanying drawings. It is noted that the invention is not limited to the specific embodiments described herein. Such embodiments are presented herein for illustrative purposes only. Additional embodiments will be apparent to persons skilled in the relevant art(s) based on the teachings contained herein.

### BRIEF DESCRIPTION OF THE DRAWINGS/FIGURES

The accompanying drawings, which are incorporated herein and form a part of the specification, illustrate embodiments of the present application and, together with the description, further serve to explain the principles of the embodiments and to enable a person skilled in the pertinent art to make and use the embodiments.

FIG. 1 shows a block diagram of a system for service to service SSH with authentication and SSH session reauthentication, according to an example embodiment.

FIG. 2 shows an interaction diagram for example methods for establishing a service-to-service SSH session and reauthenticating an SSH session, according to an example embodiment.

FIG. 3 shows an interaction diagram for an example method of using a service-to-service SSH session, according to an example embodiment.

FIG. 4 shows a flowchart of an example method for establishing and maintaining an SSH session, according to an example embodiment.

FIG. 5 shows a flowchart of an example method for establishing a service-to-service SSH session, according to an example embodiment.

FIG. 6 shows a flowchart of an example method for maintaining and terminating an SSH session, according to an example embodiment.

FIG. 7 shows a block diagram of an example computing device that may be used to implement example embodiments.

The features and advantages of the present invention will become more apparent from the detailed description set forth below when taken in conjunction with the drawings, in which like reference characters identify corresponding elements throughout. In the drawings, like reference numbers generally indicate identical, functionally similar, and/or structurally similar elements. The drawing in which an element first appears is indicated by the leftmost digit(s) in the corresponding reference number.

### DETAILED DESCRIPTION

### I. Introduction

The present specification and accompanying drawings disclose one or more embodiments that incorporate the features of the present invention. The scope of the present invention is not limited to the disclosed embodiments. The disclosed embodiments merely exemplify the present invention, and modified versions of the disclosed embodiments are also encompassed by the present invention. Embodiments of the present invention are defined by the claims appended hereto.

References in the specification to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an example embodiment, it is submitted that it is within the knowledge of one skilled in the art to effect such feature, structure, or characteristic in connection with other embodiments whether or not explicitly described.

In the discussion, unless otherwise stated, adjectives such as “substantially” and “about” modifying a condition or relationship characteristic of a feature or features of an example embodiment of the disclosure, are understood to mean that the condition or characteristic is defined to within tolerances that are acceptable for operation of the embodiment for an application for which it is intended.

Numerous exemplary embodiments are described as follows. It is noted that any section/subsection headings provided herein are not intended to be limiting. Embodiments are described throughout this document, and any type of embodiment may be included under any section/subsection. Furthermore, embodiments disclosed in any section/subsection may be combined with any other embodiments described in the same section/subsection and/or a different section/subsection in any manner.

### II. Example Implementations

Secure Shell (SSH) is an application that may be used for secure remote connections and traffic tunneling. SSH may allow a user to establish an SSH connection (e.g., as an operating system user) based on manual authentication. SSH allows a user to authenticate, for example, using a password, a private key, a certificate, a pluggable authentication module (PAM), or a generic security services application program interface (GSSAPI). These techniques are insufficient to authenticate services to an SSH service (e.g., as opposed to personal users). Password, private key and certificate authentications involve manual handling of credentials, secrets and revocations. Adding a system for services on top of a system designed for user connections may involve developing and managing many components. Further, SSH connections last forever for users, which may not be secure for user or service connections. An SSH connection lasting forever, even after a service is no longer authorized to access an SSH resource, may be undesirable.

Authentication and trust between two services may be implemented, for example, with OAuth. OAuth's client-credentials flow may be implemented for service-to-service authentications. An initial SSH login may be implemented, for example, using OAuth client-credentials flow token authentication. Any SSH connection (e.g., user to service, service to service) may be renewed, for example, with one or more new tokens (e.g., issued periodically, for example, by an OAuth provider).

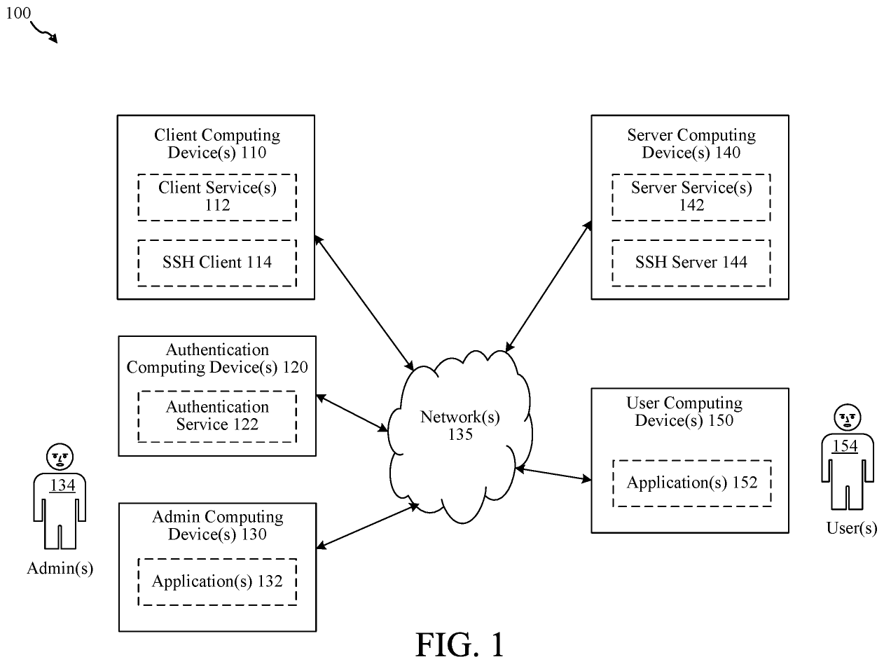

FIG. 1 shows a block diagram of a system for service to service SSH with authentication and SSH session reauthentication, according to an example embodiment. Example system 100 presents one of many possible example implementations. System 100 may comprise any number of computing devices (e.g., including servers), such as example components illustrated in FIG. 1 and other additional or alternative devices not expressly illustrated. Other types of computing environments are also contemplated. Example system 100 includes network(s) 135, administrator (admin) computing device(s) 130, client computing device(s) 110, server computing device(s) 140, authentication computing device(s) 120 and user computing device(s) 150.

Network(s) 135 may include one or more of any of a local area network (LAN), a wide area network (WAN), a personal area network (PAN), a combination of communication networks, such as the Internet, and/or a virtual network. In example implementations, admin computing device(s) 130, client computing device(s), 110, server computing device(s) 140, authentication computing device(s) 120 and user computing device(s) 150 may be communicatively coupled via network(s) 135. In an implementation, any one or more of admin computing device(s) 130, client computing device(s) 110, server computing device(s) 140, authentication computing device(s) 120 and user computing device(s) 150 may communicate (e.g. via network(s) 135) via one or more application programming interfaces (APIs), and/or according to other interfaces and/or techniques. Admin computing device(s) 130, client computing device(s) 110, server computing device(s) 140, authentication computing device(s) 120 and user computing device(s) 150 may each include at least one network interface that enables communications with each other. Examples of such a network interface, wired or wireless, include an IEEE 802.11 wireless LAN (WLAN) wireless interface, a Worldwide Interoperability for Microwave Access (Wi-MAX) interface, an Ethernet interface, a Universal Serial Bus (USB) interface, a cellular network interface, a Bluetooth™ interface, a near field communication (NFC) interface, etc. Further examples of network interfaces are described elsewhere herein. Various communications between networked components may utilize, for example, HTTP, Open Authorization (OAuth), which is a standard for token-based authentication and authorization over the Internet). Information in communications may be packaged, for example, as JSON or XML files.

Admin computing device(s) 130 may comprise one or more virtual machines, storage devices, servers, operating systems, applications, services, local processes, remote machines, web services, etc. that may be executed, hosted, and/or stored therein or via one or more other computing devices via network(s) 135. Admin computing device(s) 130 may represent any number of computing devices. Admin computing device(s) 130 may each be any type of stationary or mobile computing device, including a mobile computer or mobile computing device (e.g., a Microsoft® Surface® device, a personal digital assistant (PDA), a laptop computer, a notebook computer, a tablet computer such as an Apple iPad™, a netbook, etc.), a mobile phone, a wearable computing device, or other type of mobile device, or a stationary computing device such as a desktop computer or PC (personal computer), or a server. Admin computing device(s) 130 are not limited to physical machines, but may include other types of machines or nodes, such as a virtual machine.

Admin computing device(s) 130 may be used (e.g., by admin(s) 134), for example, to configure computer and network hardware and software, and to create and/or manage user and service identities and credentials, credential requirements, user privileges (e.g., authorizations), log-in procedures, etc. Admin(s) 134 may have administrative privileges on all or a portion of client computing device(s) 110, authentication computing device(s) 120 and/or server computing device(s) 140. In an example, admin(s) 134 may be administrators for one or more enterprises (e.g. companies) with private networks (PNs) and/or for a cloud computing network that provides cloud computing services to enterprises. Admin computing device(s) 130 may execute one or more applications (e.g., application(s) 132). Application(s) 132 may comprise, for example, a Web browser and/or one or more Web applications, which may be provided, for example, by authentication computing device(s) 120, client computing device(s) 110 and/or server computing device(s) 140. Admin(s) 134 may, for example, create and/or manage access to one or more client services (e.g., client service(s) 112). Admin(s) 134 may, for example, create and/or manage access to one or more server services (e.g., server service(s) 142). Admin(s) 134 may use application(s) 132, for example, to interact with authentication service 122, to create and/or manage identities, authentication credentials, such as an identifier and a secret (e.g., password), and authorizations for users, such as user(s) 154. Managed authorizations may include, for example, access to a client/enterprise PN (e.g., client computing device(s) 110) and/or to services therein (e.g., client service(s) 112), remote access to the client/enterprise PN via an SSH session, access to server network and/or to services therein (e.g., server service(s) 142, such as a cloud computing service), etc. Admin(s) 134 may use application(s) 132, for example, to interact with authentication service 122, to create and/or manage identities, authentication credentials, such as an identifier and a secret (e.g., password), and authorizations for services, such as client service(s) 112.

A PN may be secured behind a firewall, routers and other devices that may prevent remote access. A PN may not process a request unless it was created within the PN. A secure tunnel may be created (e.g. in a cloud network utilized by the PN) to get requests to the PN. SSH is one of multiple protocols that may be used to establish a secure connection, but SSH alone may not be secure enough, for example, given that SSH connections are only authenticated once and may last forever.

Client computing device(s) 110 may comprise one or more virtual machines, storage devices, servers, operating systems, applications, services, local processes, remote machines, web services, etc. that may be executed, hosted, and/or stored therein or via one or more other computing devices via network(s) 135. Client computing device(s) 110 may represent any number of computing devices. Client computing device(s) 110 may each be any type of stationary or mobile computing device, including a mobile computer or mobile computing device (e.g., a Microsoft® Surface® device, a personal digital assistant (PDA), a laptop computer, a notebook computer, a tablet computer such as an Apple iPad™, a netbook, etc.), a mobile phone, a wearable computing device, or other type of mobile device, or a stationary computing device such as a desktop computer or PC (personal computer), or a server. Client computing device(s) 110 are not limited to physical machines, but may include other types of machines or nodes, such as a virtual machine.

Client computing device(s) 110 may be part of a private network (PN), for example, for a business enterprise. Client computing device(s) 110 may provide client service(s) 112, for example, for use by one or more users (e.g., user(s) 154). Client computing device(s) 110 may access server computing device(s) 140, for example, to utilize server service(s) 142, such as a cloud computing service. One or more client computing device(s) 110 may be configured, for example, as a Web server (e.g., for a client PN). A Web server may, for example, serve requests received over a network (e.g., network(s) 135). One or more client computing device(s) 110 may be configured, for example, as an SSH session “connector,” which may, for example, participate in establishing, maintaining and/or terminating an SSH connection/session. A “connector” client computing device may implement an SSH client (e.g., SSH client 114) in an SSH client-server connection/session. Client computing device(s) 110 (e.g., PN) may use authentication service 122 (e.g., an OAuth provider), for example, to create, manage and verify credentials for users and/or services. SSH client 114 may be wrapped, for example, with code that manages automated authentication for a service, where authentication may be triggered based on a need for a service-to-service SSH connection/session. The code (e.g., wrapper) may then use SSH client 114 to provide the service authentication to the other side of the SSH connection (e.g., at SSH server 144) to establish a service-to-service SSH connection.

Server computing device(s) 140 may comprise one or more virtual machines, storage devices, servers, operating systems, applications, services, local processes, remote machines, web services, etc. that may be executed, hosted, and/or stored therein or via one or more other computing devices via network(s) 135. Server computing device(s) 140 may represent any number of computing devices. Server computing device(s) 140 may each be any type of stationary or mobile computing device, including a mobile computer or mobile computing device (e.g., a Microsoft® Surface® device, a personal digital assistant (PDA), a laptop computer, a notebook computer, a tablet computer such as an Apple iPad™, a netbook, etc.), a mobile phone, a wearable computing device, or other type of mobile device, or a stationary computing device such as a desktop computer or PC (personal computer), or a server. Server computing device(s) 140 are not limited to physical machines, but may include other types of machines or nodes, such as a virtual machine.

Server computing device(s) 140 may provide server service(s) 142, for example, for use by client computing device(s) 110, admin computing device(s) 130, and/or user computing device(s) 150. Users (e.g., user(s) 154) and services (e.g. client service(s) 112) may use server service(s) 142. One or more server computing device(s) 140 may be accessed by one or more client computing device(s) 110, admin computing device(s) 130 and/or user computing device(s) 150, for example, to utilize server service(s) 142, such as a Web server and/or a cloud computing service. One or more server computing device(s) 140 may be configured as a Web server, for example, to serve requests received over a network (e.g., network(s) 135). One or more server computing device(s) 140 may be configured, for example, as an SSH session “connector hub,” which may, for example, participate in establishing, maintaining and/or terminating an SSH connection/session. An SSH “connector hub” server computing device may implement an SSH server (e.g., SSH server 144). SSH “connector hub” server computing device may validate access information (e.g., a token comprising credentials encrypted with a private key in a private/public key pair) to determine whether to establish, maintain and/or terminate an SSH connection (e.g., a user-to-service SSH connection and/or a service-to-service SSH connection). Access information may be provided by an SSH “connector” client computing device. For example, an SSH “connector hub” server computing device operating system may analyze access information (e.g., using a public key from a private/public key pair). An SSH “connector hub” server computing device may implement an SSH connection/session, for example, upon validating access information, which may be provided by an SSH “connector” client computing device. User(s) 154 may provide access information (e.g., an access token with encrypted credentials) or credentials to server computing device(s) 140, for example, for validation and access to one or more services provided by one or more server computing device(s) 140 (e.g., a Web server, a cloud computing service, etc.). User(s) 154 may provide access information (e.g., an access token with encrypted credentials) or credentials to server computing device(s) 140, for example, for access to one or more services provided by one or more client computing device(s) 110 (e.g., a Web server service provided by the client PN over a service-to-service SSH connection/session). Client service(s) 112 may otherwise be inaccessible to user(s) 154, for example, if client computing device(s) 110 are within a PN.

User computing device(s) 150 may comprise any computing device utilized by one or more users (e.g., individual users, family users, enterprise users, governmental users, etc.). User computing device(s) 150 may comprise one or more applications, operating systems, virtual machines, storage devices, etc. that may be executed, hosted, and/or stored therein or via one or more other computing devices via network(s) 135. User computing device(s) 150 may each be any type of stationary or mobile computing device, including a mobile computer or mobile computing device (e.g., a Microsoft® Surface® device, a personal digital assistant (PDA), a laptop computer, a notebook computer, a tablet computer such as an Apple iPad™, a netbook, etc.), a mobile phone, a wearable computing device, or other type of mobile device, or a stationary computing device such as a desktop computer or PC (personal computer), or a server. User computing device(s) 150 are not limited to physical machines, but may include other types of machines or nodes, such as a virtual machine. User computing device(s) 150 may each interface with authentication computing device(s) 120 through APIs and/or by other mechanisms. Any number of program interfaces may coexist on user computing device(s) 150.

User computing device(s) 150 may be used, for example, by user(s) 154 to access computing resources (e.g., client computing device(s) 110, client service(s) 112, server computing device(s) 140, server service(s) 142), which may require user authentication. Application(s) 152 may comprise any type and number of applications, e.g., Web browser application(s), word processing application(s), and so on, which may be Web-based applications. User(s) 154 may use one or more application(s) 152, for example, to access network(s) 135, server computing device(s) 140, and/or client computing device(s) 110. User(s) 154 may use one or more application(s) 152 to create one or more (e.g. personal, business and/or other) identities associated with one or more sets of credentials and authorizations, which may be managed, for example, by authentication service 122. User 130 may (e.g. additionally and/or alternatively), for example, have a role (e.g. engineer, accountant, manager, executive, contractor) within one or more enterprises (e.g., for client enterprise operating client computing device(s) 110), which may identify authorizations for user(s) 154. In an example, user computing device(s) 150 may access one or more server computing device(s) 140, such as a Web server and/or an SSH “connection hub” server computing device, to access one or more secured resources (e.g. cloud services, SSH connection to client PN, such as a cloud tunnel server, applications, databases, and so on).

Authentication computing device(s) 120 may comprise one or more virtual machines, storage devices, servers, operating systems, applications, services, local processes, remote machines, web services, etc. that may be executed, hosted, and/or stored therein or via one or more other computing devices via network(s) 135. Authentication computing device(s) 120 may represent any number of computing devices. Authentication computing device(s) 120 may each be any type of stationary or mobile computing device, including a mobile computer or mobile computing device (e.g., a Microsoft® Surface® device, a personal digital assistant (PDA), a laptop computer, a notebook computer, a tablet computer such as an Apple iPad™, a netbook, etc.), a mobile phone, a wearable computing device, or other type of mobile device, or a stationary computing device such as a desktop computer or PC (personal computer), or a server. Authentication computing device(s) 120 are not limited to physical machines, but may include other types of machines or nodes, such as a virtual machine.

Access control for client service(s) 112 and user(s) 154 may be provided by authentication and authorization. Authentication is a process of proving that a user or service is legitimate. Authentication may challenge a party (e.g., a user or service) for legitimate credentials (e.g. username and secret, such as a password), for example, as a basis to create a security principal used for identity and access control. Authorization is the act of granting an authenticated security principal permission to do something. Authorization may specify what data a party (e.g. user or service) is allowed to access and what the party can do with it.

Authentication computing device(s) 120 may provide user authentication services to many services and users that may be, for example, associated with many different clients/customers (e.g. personal, business and/or other accounts) of authentication computing device(s) 120. Admin(s) 134 from each client/customer may access authentication service 122 to control user identity and access information for their respective employees and customers. User authentication and authorization may be decoupled from resources. Decoupling user authentication and authorization from resources may permit authentication and authorization definitions (specifications) to apply across a plurality of resources (e.g. inter-resource or cross-resource definition). Resources may validate user authentication and authorization, for example, by validating a token provided by a user or service. Decoupling user authentication and authorization from resources permits centralized management of user identities and access privileges to information and resources. An authorization server may be integrated with or separate from authentication computing device(s) 120. An authorization service may provide authorization services, for example, by maintaining and providing user permissions. An authorization server may be implemented, for example, as a cloud authorization service.

Secured resources (e.g. resources secured by user authentication and/or authorization) may include any type of resource, including but not limited to computing or processing resources (e.g., cloud computing), an SSH connection, remote access, software resources (e.g., software as a service (SaaS), platform as a service (PaaS), etc.), storage resources (e.g., physical storage devices, local storage devices, cloud-based storages, hard disk drives, solid state drives, random access memory (RAM) devices, etc.), databases, etc.

Authentication service 122 may be configured to receive and validate authentication information (e.g., credentials) provided by services (e.g., client service(s) 112) and users (e.g. user(s) 154). Authentication service 122 may authenticate credentials, for example, that may be provided (e.g. in exchange for access information, such as token(s)) to establish and maintain an SSH connection/session (e.g., a service-to-service or a user-to-service SSH connection/session). For example, authentication service 122 may receive authentication information from client service(s) 112 for access information client service(s) 112 may provide to server service(s) 142 to establish and/or to maintain an SSH connection/session. Authentication information (e.g., credentials) may comprise any information that may be used to verify service or user identity. Credential categories may be generalized as something a user knows (e.g. answers to one or more prompts or questions, such as a username, a password, and so on), something a user has (e.g. a device that receives a one-time code (OTC), a device storing a cryptographic key and so on) or something a user is (e.g. biometric information, such as retina scan, face scan, fingerprint and so on). Multi-factor authentication (MFA) may combine multiple types of credentials. A username may comprise any string of characters, images (e.g. pattern with coded data) or blob of information. In an example, a username may comprise a random string of characters, a cellular telephone number, an email address and so on. A password may comprise any string of characters and/or images (e.g. pattern with coded data). In an example, a password may comprise a one-time code (OTC), automatically sent during a login procedure to ensure that the entity logging in controls a device or account, such as a computing device or account address that may be specified during the creation of a user identity.

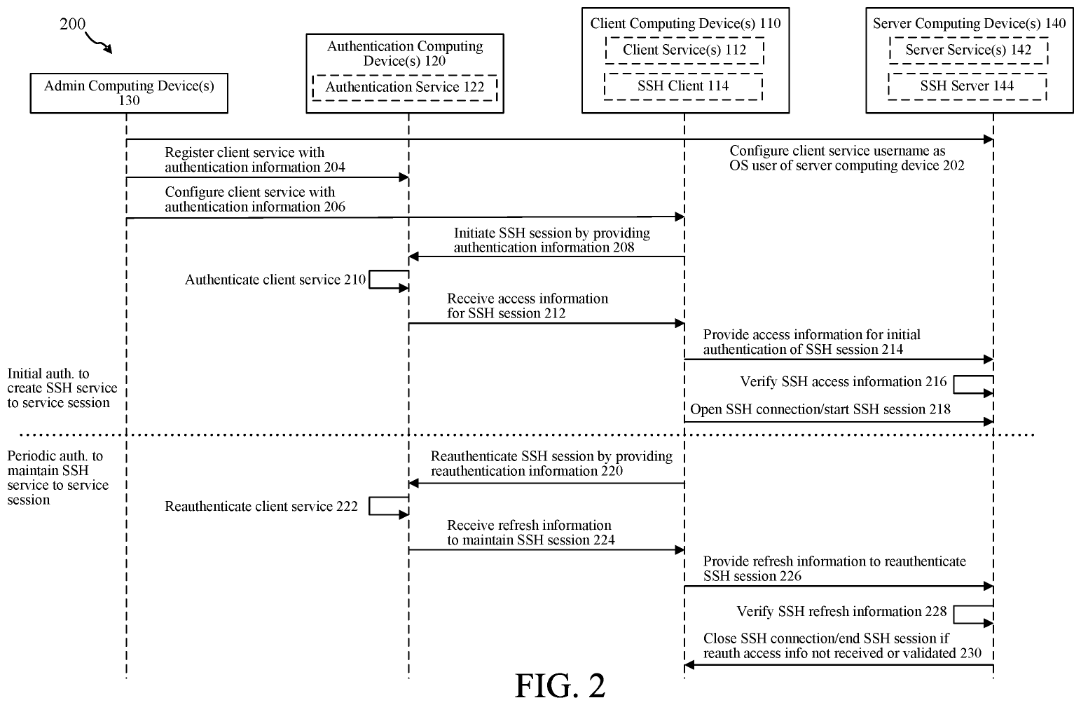

FIG. 2 shows an interaction diagram of example methods for establishing a service-to-service SSH session and reauthenticating an SSH session, according to an example embodiment. Example interaction diagram 200 presents one of many possible example implementations. Embodiments disclosed herein and other embodiments may operate in accordance with example interaction diagram 200. Example interaction diagram 200 comprises steps 202-228. However, other embodiments may operate according to other interactions, with the same, different, more or fewer interaction participants and/or steps. There is no requirement that an interaction embodiment implement all of the interaction participants or steps illustrated in FIG. 2. FIG. 2 is simply one of many possible embodiments. Other structural and operational embodiments will be apparent to persons skilled in the relevant art(s) based on the discussion of embodiments. No order of steps is required unless expressly indicated or inherently required.

Example interaction diagram 200 is based on one of multiple techniques that may be used to establish, maintain and terminate an SSH connection/session. The example presented utilizes a pluggable authentication module (PAM) for authentication to establish an SSH connection/session and an SSH force command to maintain and terminate an existing SSH connection/session. For example, a user-mode script (e.g., a force command) may receive refresh authentication (e.g., reauthentication access information, such as a refresh token), which may be verified the force command, externally in a different process, or using a PAM. In an example, client service(s) 112 and server service(s) 142 may comprise OAuth applications.

In step 202, admin(s) 134 may configure one or more server computing device(s) 140 with a client service username and authentication (e.g., before client computing device attempts to establish an SSH connection/session based on the username). A server computing device(s) 140 associated with SSH server 144 (e.g., an SSH server “connector hub”) may expect (e.g., be configured to) log in an operating system (OS) user for an SSH session. A server computing device (e.g., an SSH server connector hub) may be configured (e.g., by admin(s) 134) with an OS user (e.g., a username and authentication) for one or more client service(s) 112. In an example, a client service username (e.g., “connector”) may be configured as an OS user of the (e.g., connector hub) SSH server computing device. The client service username (e.g., “connector”) may be configured/associated with a type of authentication, such as a PAM. A PAM associated with the client service username (e.g., “connector”) may be configured to authenticate the client service username based on access information (e.g., an access token) provided by authentication service 122. In an example, the username configured as a user of server computing device OS may be configured without any authorizations (e.g., disable all permissions), for example, so that client computing device(s) 110 (e.g., a cloud service client) may not access or control server computing device(s) 140 (e.g., a cloud service provider). This example may be used to create an SSH connection/session before or after user(s) 154 may attempt to log in and use a service-to-service SSH connection/session. For example, user(s) 154 may log in to use an SSH session, which (e.g., if an SSH session does not already exist) may trigger initiation of an SSH connection/session, such as step 208 shown in FIG. 2.

In step 204 admin computing device(s) 130 may be used (e.g., by admin(s) 134) to register a client service with authentication service 122 (e.g., an OAuth provider). Registration may indicate, for example, that client service(s) 112 may communicate with server service(s) 142. Service registration may return authentication information 204 (e.g., client credentials, such as a client ID and a client secret) for client service(s) 112. A client ID may comprise, for example, a client service username (e.g., “connector”) and a client secret may comprise a password.

In step 206, client service(s) 112 may be configured with authentication information created in step 204. Client computing service(s) 112 may be configured with authentication information as OAuth parameters. Client computing service(s) 112 may be configured, for example, to initiate an SSH session utilizing the authentication information. Client computing service(s) 112 may be configured, for example, to maintain an SSH session utilizing the authentication information (e.g., as reauthentication information). Client service(s) 112 may provide authentication and reauthentication information to authentication service 122. Client service(s) 112 may receive a token in exchange for each submission of authentication and reauthentication information. Client service(s) 112 may wrap SSH client 114. Client service(s) 114 may make SSH client 114 aware of the authorization information. Client service(s) 114 may cause SSH client 114 to send each token (e.g., and client service username, such as “connector”) to SSH server 144. In an example, the username may be provided as a hardcoded string (e.g., a word). In another example, (e.g., in lieu of hardcoding to a specific resource), an extension may permit user(s) 154 to connect to any resource in a client PN.

In step 208, client service(s) 112, which may include SSH client wrapper code, may initiate an SSH session by initiating an authorization flow (e.g., an OAuth flow). Client service(s) 112 may contact authentication service 122 (e.g., OAuth provider/endpoint), provide authorization information and receive access information (e.g., an access token), which may be used to establish an SSH connection/session. SSH client 114 may receive access information by other methods that use an access token to establish an SSH connection/session.

In step 210, authentication service 122 (e.g., OAuth provider) may authenticate client service(s) 112, for example, by ensuring that authentication information provided by client service(s) 112 matches the client ID and client secret created during registration 204 and/or an update thereafter. Authentication service 122 may return access information (e.g., an access token digitally signed by an OAuth provider), for example, if the authentication information provided by client service(s) 112 matches client credentials on record. Access information (e.g., an access token) may be valid for a given time, which may be indicated by an expiration time.

In step 212, client service(s) 112 may receive from authentication service 122 access information (e.g., an access token) for SSH client 114 to use to establish an SSH connection/session. In an example, an access token may comprise a JavaScript Object Notation (JSON) web token (referred to as a JWT) object signed by authentication service 122. A JWT may comprise three pieces (e.g. a header, payload or body and signature). A header may provide information about how to validate a token (e.g. including information about the type of token and how it was signed, such as the key and encryption method used to sign the token). A payload may contain data about a user or an application that may be calling an application or resource (e.g. service, database). A signature may comprise raw material that may be used to validate a token. In an example, a token issued by an authentication provider may be signed using an asymmetric encryption algorithm, such as RSA 256. Pieces of a JWT object may be separated by a period and (e.g. separately) Base64 encoded. In an example, access information (e.g., an access token) may be accompanied by metadata about the access information, for example, for consumption by an application or resource receiving the access information. In an example, metadata information may include an expiry time of access information and the scope(s) for which the access token is valid. This data may permit applications and resources to intelligently cache access information without having to parse the access information. Access information may provide helpful information for use in authentication and authorization validation, such as the user, client, issuer, permissions, etc.

In step 214, client service(s) 112 may cause SSH client 114 to provide the access information to SSH server 144 (e.g., for initial authentication of an SSH connection/session). The access information may be provided without (e.g. manual) interaction. The access information may be provided, for example, using SSHPASS, which may provide the access information to the command prompt.

In step 216, SSH server may attempt to verify SSH access information provided by SSH client 114. SSH server 144 may be configured to delegate authentication to the OS of the server computing device(s) 140 that provides SSH server 144. For example, SSH server 144 may be configured to use keyboard interactive authentication mode, which may delegate authentication of SSH client 114 to the OS. The OS may be configured to enable keyboard interactive mode and PAM authentication. A keyboard interactive mode of user authentication may be used to support PAM authentication of access information. SSH may permit elective use of a PAM. PAM may be configured for multiple types of authentication by the server computing device OS, including, for example, delegating authentication authority to authentication service 122 (e.g., OAuth). For example, a PAM associated with client service(s) 112 may be configured to accept an access token issued by authorization service 122 to authenticate SSH client 114. Thus, in examples, OAuth, SSH and PAM may be used to authenticate client service(s) 112 for a service-to-service SSH session. The OS may (e.g., upon determining client service(s) 112 username “connector” is attempting to log in) run the PAM, which may authenticate the provided access information (e.g., OAuth access token signed with a private key) using a public key in a public/private key pair.

In step 218, an SSH connection/session may be established, for example, based on the verification in step 216. SSH server 144 and/or SSH client 122 may establish the SSH connection/session after verification. For example, one or more (e.g., all) claims inside the token (e.g., a JWT) may be verified based on verification in step 216. Claims may include, for example, a tenant ID, a flag requesting creation of a network tunnel, etc. A tunnel may be created automatically (e.g., after verification), for example, based on an indication (e.g., a flag) passed in the access information. A tunnel may be used by user(s) 154, for example, to access the client PN through server computing device(s) 140 (e.g., the cloud) and over the SSH connection. A tunnel opened by a client computing device may enlist a server computing device to listen on a specific port. An SSH connection/session may establish an SSH tunnel or shell connection.

The established service-to-service SSH connection/session may be used for one or more purposes until the SSH connection/session is terminated. SSH may operate using (e.g., logical) channels. SSH client 114 may have one packet socket (e.g., a transmission control protocol (TCP) connection to SSH server 144). A port number and an IP address may identify endpoints. A socket may comprise a pair of endpoints. SSH client 114 and SSH server 144 may multiplex multiple logical channels over a single connection. A command channel may be a main channel. In an example, the command channel may be used for (e.g., OAuth) authentication. A tunnel may be another channel, etc. Multiple tunnels (e.g., multiple logical channels) may be opened, for example, to listen on different TCP sockets on a destination server. An SSH server may listen on a specific port. SSH client 114 may open multiple tunnels to listen on different ports and each tunnel may have multiple connections. SSH server 144 may interact with multiple user(s) 154 at the same time, for example, for each of multiple users to access client computing device(s) 110 (e.g., PN). Each of multiple users may have their own TCP connection as a logical channel, where the tunnel may multiplex multiple TCP connections on top of an SSH tunnel.

Any type of SSH connection/session (e.g., user-to-service, service-to-service) may be securely maintained, for example, by (e.g., periodically) refreshing access information (e.g., access tokens). Long living connections between an SSH client and SSH server may always be available to listen for incoming connections (e.g., a tunnel inside a PN). A hacker could break into long living connection to steal a client ID and secret, compromising a service (e.g., an OAuth application). An initial SSH connection/session may last for a period of time that may be defined by access information (e.g., an access token). Steps 220-230 show an example of securely maintaining a security connection and terminating an SSH connection/session, for example, if security is violated (e.g., by failing to provide reauthentication information and refresh information during a time interval and/or by providing invalid reauthentication information or refresh information).

In step 220, client service(s) 112 may perform (e.g., periodic) reauthentication, for example, by providing reauthentication information to authentication service 122. Client service(s) 112 may contact authentication service 122 (e.g., OAuth provider/endpoint), provide reauthorization information and receive refresh information (e.g., a refresh token) on behalf of SSH client 114, which may be used to maintain an existing SSH connection/session. SSH client 114 may receive refresh information by other methods that use refresh information to maintain security for an SSH connection/session.

In step 222, authentication service 122 (e.g., OAuth provider) may reauthenticate client service(s) 112, for example, by ensuring that reauthentication information provided by client service(s) 112 matches the client ID and client secret created during registration 204 and/or an update thereafter. Authentication service 122 may return refresh information (e.g., a refresh token signed by an OAuth provider), for example, if the reauthentication information provided by client service(s) 112 matches client credentials on record. Refresh information (e.g., a refresh token) may be valid for a given time, which may be indicated by an expiration time.

In step 224, client service(s) 112 may receive from authentication service 122 refresh information (e.g., a refresh token) for SSH client 114 to use to maintain an existing SSH connection/session. A (e.g., each) refresh information (e.g., refresh token) may be randomly generated. In an example, the refresh token may comprise a JWT object signed by authentication service 122. A JWT may comprise three pieces (e.g. a header, payload or body and signature). A header may provide information about how to validate the refresh token (e.g. including information about the type of token and how it was signed, such as the key and encryption method used to sign the token). A payload may contain data about a user or application that may be calling an application or resource (e.g. service, database). A signature may comprise raw material that may be used to validate a token. In an example, a token issued by an authentication provider may be signed using an asymmetric encryption algorithm, such as RSA 256. Pieces of a JWT object may be separated by a period and (e.g. separately) Base64 encoded. In an example, refresh information (e.g., a refresh token) may be accompanied by metadata about the refresh information (e.g., a refresh token), for example, for consumption by an application or resource receiving the access information. In an example, metadata information may include an expiry time of refresh information and the scope(s) for which the refresh token is valid. This data may permit applications and resources to intelligently cache access information without having to parse the refresh information. Refresh information may provide helpful information for use in authentication and authorization validation, such as the user, client, issuer, permissions, etc.

In step 226, client service(s) 112 may cause SSH client 114 to provide the refresh information to SSH server 144 over the existing SSH connection/session, for example, to reauthenticate the existing SSH connection/session. The refresh information may be provided without (e.g. manual) interaction. The refresh information may be provided, for example, using SSHPASS, which may provide the refresh information to the command prompt.

In step 228, SSH server 144 may attempt to verify the refresh information provided by SSH client 114. A force command (e.g., to SSH server 144) may be utilized for (e.g., periodic security) maintenance and termination of an existing SSH connection (e.g., any type of SSH connection). SSH client 114 may issue a force command to SSH server 144 to verify the refresh information. A force command may comprise code executed by SSH server 144 after initial verification. The code may wait during a time interval for refresh information. The code may have a first command that waits for refresh information and if the refresh information does not arrive periodically (e.g. 1 min, 2 min or other timeout of a timer) then the existing SSH connection/session may be terminated, including tunnels. The code may perform similarly to the PAM (e.g. run a verification procedure), for example, if refresh information is timely received (e.g., during a time interval). The code may authenticate the provided refresh information (e.g., an OAuth refresh token signed with a private key) using a public key in a public/private key pair. The SSH session may continue to be used as long as (e.g. periodic) security is maintained.

In step 230, an SSH connection/end SSH session may be terminated, for example, if refresh information is not timely received (e.g., during an interval) or if refresh information is not validated. SSH server 144 may (e.g., based on force command code for a security refresh procedure) disconnect the SSH connection, for example, if there is no valid refresh information for a refresh (e.g., periodic) time interval (e.g., because refresh information was not timely provided and/or was not validated), indicating SSH client 114 is no longer trusted.

An SSH session may be (e.g., configured to be) terminated, for example, by SSH client 114, SSH server 144, client service(s) 112, server service(s) 142 and/or otherwise automatically or manually (e.g., by admin(s) 154). An SSH session may be terminated, for example, by disabling client service(s) 112 (e.g., “connector” service OAuth application). An SSH session may be terminated, for example, by changing a refresh policy or otherwise refusing to issue refresh information.

OAuth may be used, for example, to establish and renew an SSH connection/session. In an example, the command channel may be used for (e.g., OAuth) authentication and reauthentication. Other types of authentication may be utilized.

The two aspects shown in FIG. 2 (e.g., establishing a service-to-service SSH connection/session and maintaining security for, including terminating, any type of SSH connection) may be implemented individually or in combination. A service-to-service SSH connection may have a shell or tunnel connection. SSH connections between two services may be established automatically to be secure, efficient and scalable. Service-to-service SSH connections may be used, for example, to enable enterprise users to remotely interact with their enterprise devices over a secure connection. For example, one or more (e.g., many) users may utilize a service-to-service SSH connection/session (e.g., for secure remote access to a PN, for example, as opposed to a single user using a single user-to-service SSH connection). SSH security maintenance and termination may be applicable to a tunnel SSH connection (e.g., for user-to-service and service-to-service) and may use the SSH command channel for (e.g., periodic) (re)authentication by any type of authentication (e.g., token, such as OAuth or otherwise; password reauthentication; and so on) for a user or a service. The first and second aspects may be combined, for example, in a tunnel server. SSH maintenance/termination may

SSH tunnel management (e.g., on premises proxy providers) may be combined with authorization (e.g., an OAuth provider), which may provide multi-tenant, cloud-based application access management, and identity protection. Users may manage their connections (e.g., SSH connections), for example, using tools they may already know (e.g., Microsoft Azure Portal). Connections may be secured, for example, even while the SSH connections exist, and they may be verified by a cloud authentication service.

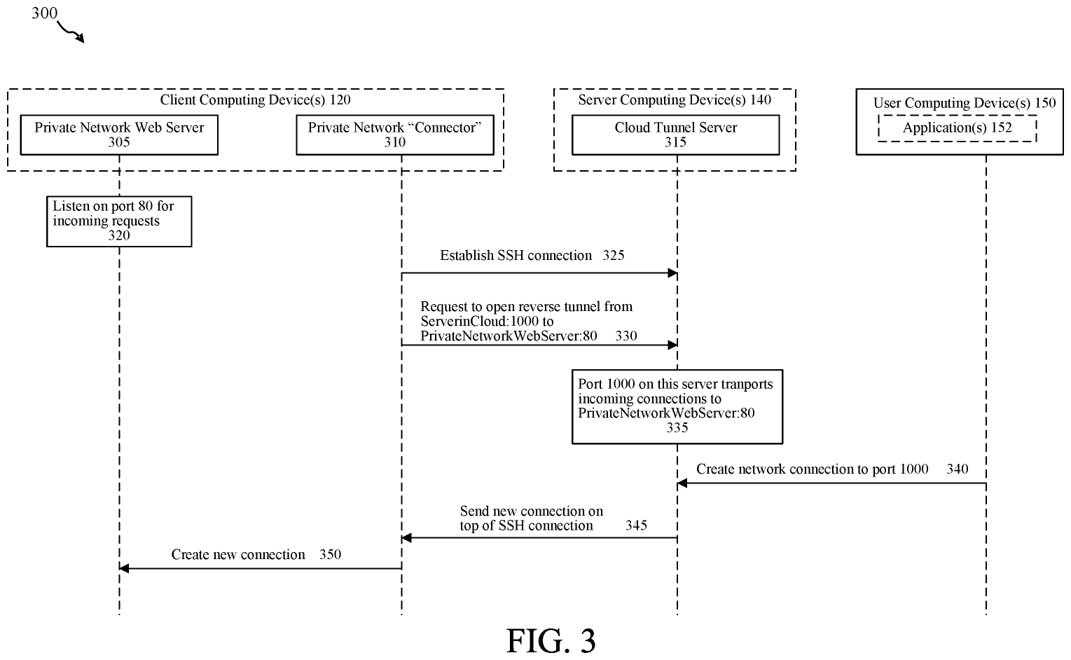

FIG. 3 shows an interaction diagram for an example method of using a service-to-service SSH session, according to an example embodiment. FIG. 3 shows one of many uses of a service-to-service SSH connection/session. Example interaction diagram 300 shows an example of remote user(s) 154 using user computing device(s) 150 with Internet access to access a private network (e.g., operated by their employer) through server computing device(s) 140 (e.g., cloud computing servers utilized by the PN) through a service-to-service reverse tunnel SSH connection/session established and/or maintained, for example, as shown and described with respect to FIG. 2. User(s) 154 may not have anything to do with SSH connection/session establishment or maintenance. Service-to-service SSH connection/session may provide a secure conduit for user(s) 154 to access client's PN. User(s) can access communications relayed to the client PN over (e.g., on top of) an established SSH tunnel even though the PN may not have a public IP address. An SSH connection may provide, for example, a command channel and a TCP tunnel. Communication traffic (e.g., rather than commands) may flow over the command channel (e.g., command channel may be repurposed in this example and/or other examples). Admin(s) 154 may configure server computing device(s) 140 and/or client computing device(s) 120 to implement this example and/or other examples. User traffic may be injected into the open service-to-service SSH tunnel, for example, by passing user traffic through filters, which may, for example, determine whether/ensure each user is authenticated, has permission/authorization to use tunnel and so on.

Client computing device(s) 120 may comprise, for example, private network web server (PNWS) 305 and PN “connector” 310. PNWS 305 may service incoming requests received from network(s) 135. PNWS 305 may not have a public IP address. PN connector 310 may be a client service running on a designated machine in client's PN that connects via SSH to a server service (“connector hub”) running on a designated machine (e.g., cloud tunnel server) among server computing device(s) 140. Server computing device(s) 140 may comprise, for example, cloud tunnel server 315. Cloud tunnel server 315 may provide an SSH server and “connector hub” service. Cloud tunnel server 315 may forward communications between user computing device(s) 150 and private network “connector” 310. User computing device(s) 150 may comprise, for example, application(s) 152. Application(s) 152 may comprise any type and number of applications, e.g., Web browser application(s), word processing application(s), and so on, which may be Web-based applications. User(s) 154 may use one or more application(s) 152, for example, to access network(s) 135, server computing device(s) 140, and/or client computing device(s) 110.

No order of steps is expressed or implied. In various examples, step 325 and/or other steps may be triggered, for example, by step 340.

In step 320, PNWS 315 may be configured to listen on a port (e.g., port 80) for incoming requests.

In step 325, PN connector 310 may establish an SSH connection, for example, as described herein (see, e.g., FIG. 2 and accompanying discussion).

In step 330, PN connector 310 may request that cloud tunnel server 315 open a reverse tunnel, for example, from ServerinCloud:1000 to PrivateNetworkWebServer:80. For example, the request may be provided in access information provided by SSH client to SSH server or may be provided following establishment of an SSH connection/session. There may be (e.g., when the tunnel is initialized) a designated port with port forwarding to a port on connector (e.g., PN SSH client with assigned username “connector”)

In step 335, cloud tunnel server 315 may configure port 1000 to transport incoming connections to PNWS port 80 (PrivateNetworkWebServer:80). Cloud tunnel server 315 may listen on the configured port 1000 and may forward to configured port 80 of PNWS 305.

In step 340, user computing device(s) 150 may (e.g., after logging in to server computing device(s) 140, such as a cloud computing service) set up a connection to SSH server (e.g., cloud tunnel server 315) port 1000 that the SSH server listens to. In an example, step 340 may be triggered by user(s) 154 logging in to server computing device(s) 140. User(s) 154 may (e.g., first) log in to an (e.g., a cloud server) account via user computing device(s) 150 and network(s) 135. User(s) 154 may, for example, (i) launch server service(s) 142 (e.g. through a Web browser application(s) 152), (ii) select “sign-in,” (iii) be redirected to authentication computing device(s) 120, (iii) be presented with a request to provide credentials, (iv) provide credentials (e.g. username and password), (v) have credentials validated, (vi) be placed in session with an identity associated with the validated credentials and (vii) be redirected back to server service(s) 142. The service that user(s) 154 may have accessed may be an SSH remote access service, which may allow user(s) 154 to interact with one or more client computing device(s) 110 over an existing SSH connection/session between client computing device(s) 110 and server computing device(s) 140. User(s) 154 may use an SSH remote access service to access resources on client computing device(s) 110, such as a Web application (e.g. Microsoft® Office 365® Web applications) or a locally executed application (e.g. Microsoft® Office Word, Excel®).

In step 345, cloud tunnel server 315 may send a new connection request on top of an (e.g., existing) SSH connection. Cloud tunnel server 315 may relay communications on top of an (e.g., existing) SSH connection (e.g., tunnel/port forwarding established in step 325). Multiple user(s) 154 may be multiplexed over the SSH connection. SSH client “connector” may be configured or otherwise be aware of how to forward communications to/from PNWS 305, for example, based on configured port 80 for PNWS 305.

In step 350, PN connector 310 may create the new connection in response to the request from cloud tunnel server 315. The connection may be utilized, for example, by allowing user(s) 154 to remotely access client PN. PNWS 305 may service requests provided by user computing device(s) 150 (e.g., for one or more application(s) 152 used by user(s) 154).

As previously indicated, where SSH maintenance and termination are integrated with the service-to-service SSH connection/session, cloud tunnel server 315 may terminate the service-to-service SSH connection, for example, if refresh information is not timely received or is not validated. Termination of the SSH connection may (e.g., in turn) terminate other connections shown in FIG. 3 (e.g., by virtue of logical channels in the SSH connection/session).

Implementations are not limited to the examples shown. Example system 100 or components therein, and/or other systems and components in other examples may operate, for example, according to example interaction diagrams and methods presented in FIGS. 2-6.

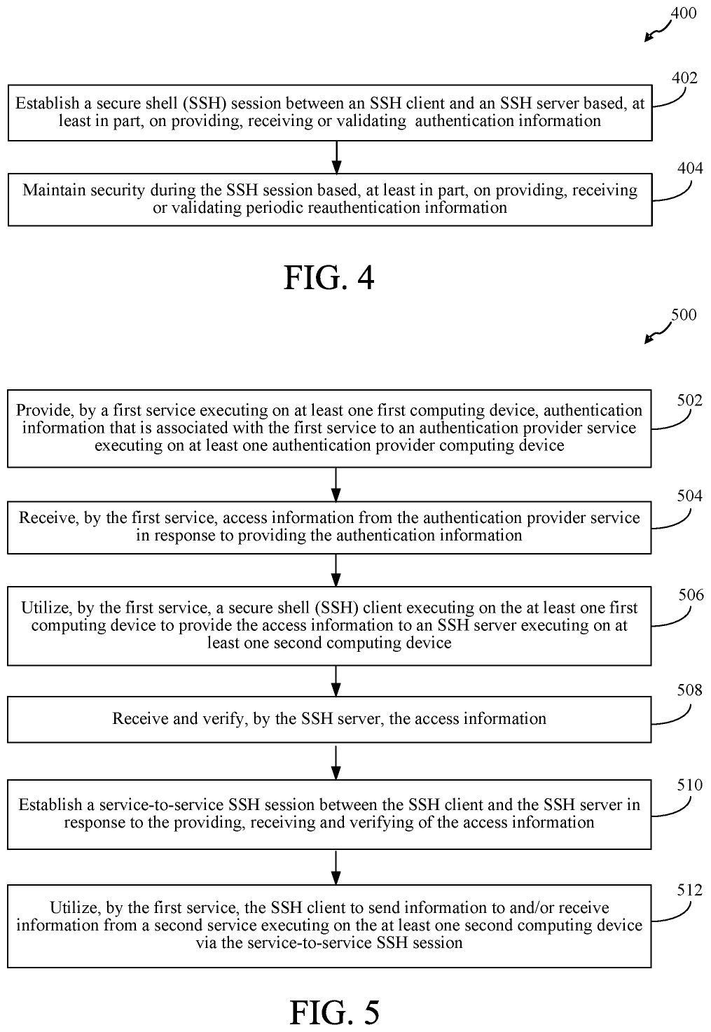

Embodiments may be implemented in processes or methods. For example, FIG. 4 shows a flowchart of an example method for establishing and maintaining an SSH session, according to an example embodiment. Embodiments disclosed herein and other embodiments may operate in accordance with example method 400. Method 400 comprises steps 402-404. However, other embodiments may operate according to other methods. Other structural and operational embodiments will be apparent to persons skilled in the relevant art(s) based on the foregoing discussion of embodiments. No order of steps is required unless expressly indicated or inherently required. There is no requirement that a method embodiment implement all of the steps illustrated in FIG. 4. FIG. 4 is simply one of many possible embodiments. Embodiments may implement fewer, more or different steps.

In step 402, a secure shell (SSH) session may be established between an SSH client and an SSH server based, at least in part, on providing, receiving or validating authentication information. For example, as shown in FIGS. 1 and 2, a service-to-service SSH connection/session may be established based, at least in part, on client service(s) 112 providing authentication information to authentication service 122, e.g., in exchange for access information that SSH client 114 may provide to SSH server 144.

In step 404, security during the SSH session may be maintained based, at least in part, on providing, receiving or validating periodic reauthentication information. For example, as shown in FIGS. 1 and 2, a service-to-service SSH connection/session may be maintained based, at least in part, on client service(s) 112 providing reauthentication information to authentication service 122, e.g., in exchange for refresh information that SSH client 114 may provide to SSH server 144.

FIG. 5 shows a flowchart of an example method for establishing a service-to-service SSH session, according to an example embodiment. Embodiments disclosed herein and other embodiments may operate in accordance with example method 500. Method 500 comprises steps 502-512. However, other embodiments may operate according to other methods. Other structural and operational embodiments will be apparent to persons skilled in the relevant art(s) based on the foregoing discussion of embodiments. No order of steps is required unless expressly indicated or inherently required. There is no requirement that a method embodiment implement all of the steps illustrated in FIG. 5. FIG. 5 is simply one of many possible embodiments. Embodiments may implement fewer, more or different steps.

In step 502, a first service executing on at least one first computing device may provide authentication information that is associated with the first service to an authentication provider service executing on at least one authentication provider computing device. For example, as shown in FIGS. 1 and 2, client service(s) 112 may provide authentication information to authentication service 122, e.g., in exchange for access information that SSH client 114 may provide to SSH server 144. The authentication information may be associated with client service(s) 112, based on registration, where client service(s) 112 may be registered with authentication service 122 and may receive authentication information based on the registration.

In step 504, the first service may receive access information from the authentication provider service in response to providing the authentication information. For example, as shown in FIGS. 1 and 2, client service(s) 112 may receive access information from authentication service 122, e.g., after authentication of the authentication information.

In step 506, the first service may utilize a secure shell (SSH) client executing on the at least one first computing device to provide the access information to an SSH server executing on at least one second computing device. For example, as shown in FIGS. 1 and 2, client service(s) 112 may use SSH client 114 to provide the access information to SSH server 144.

In step 508, the SSH server may receive and may verify the access information. For example, as shown in FIGS. 1 and 2, SSH server 144 may receive and may verify access information provided by SSH client 114.

In step 510, a service-to-service SSH session may be established between the SSH client and the SSH server in response to the providing, receiving and verifying of the access information. For example, as shown in FIGS. 1 and 2, an SSH connection/session may be established between SSH server 144 and SSH client 114 in response to SSH client 114 providing and SSH server 144 receiving and verifying the access information.

In step 512, the first service may utilize the SSH client to send information to and/or receive information from a second service executing on the at least one second computing device via the service-to-service SSH session. For example, as shown in FIGS. 1 and 2, client service(s) 112 may utilize SSH client 114 to send information to server service(s) 142 via the SSH connection/session.

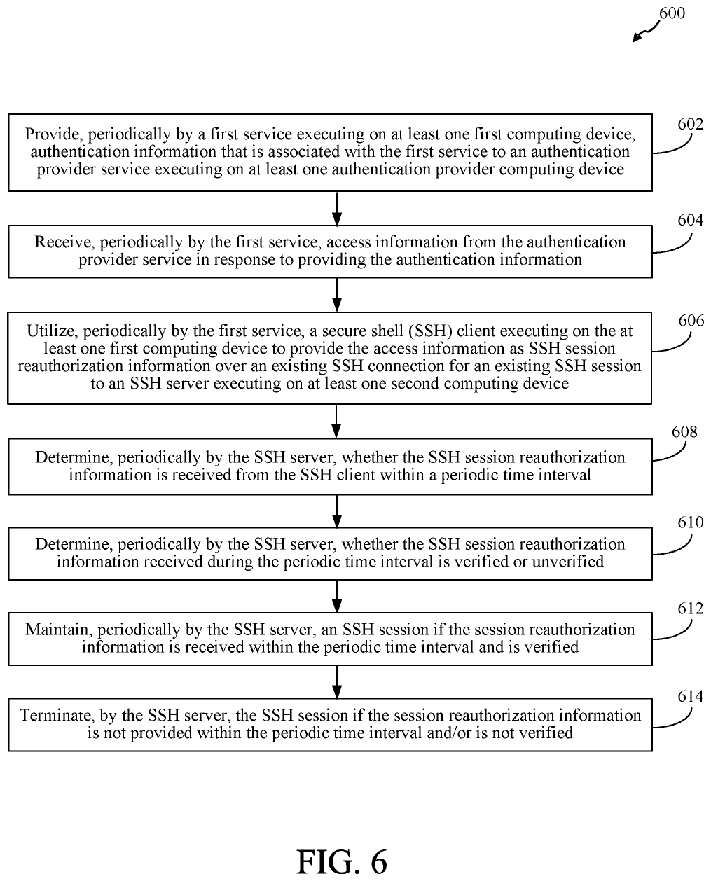

FIG. 6 shows a flowchart of an example method for maintaining and terminating an SSH session, according to an example embodiment. Embodiments disclosed herein and other embodiments may operate in accordance with example method 600. Method 600 comprises steps 602-614. However, other embodiments may operate according to other methods. Other structural and operational embodiments will be apparent to persons skilled in the relevant art(s) based on the foregoing discussion of embodiments. No order of steps is required unless expressly indicated or inherently required. There is no requirement that a method embodiment implement all of the steps illustrated in FIG. 6. FIG. 6 is simply one of many possible embodiments. Embodiments may implement fewer, more or different steps.

In step 602, a first service executing on at least one first computing device may periodically provide authentication information that is associated with the first service to an authentication provider service executing on at least one authentication provider computing device. For example, as shown in FIGS. 1 and 2, client service(s) 112 may provide reauthentication information to authentication service 122, e.g., in exchange for refresh information that SSH client 114 may provide to SSH server 144. The reauthentication information may be associated with client service(s) 112, based on registration, where client service(s) 112 may be registered with authentication service 122 and may receive (re)authentication information based on the registration.

In step 604, the first service may periodically receive access information from the authentication provider service in response to providing the authentication information. For example, as shown in FIGS. 1 and 2, client service(s) 112 may receive refresh information from authentication service 122, e.g., after authentication of the reauthentication information.

In step 606, the first service may periodically utilize a secure shell (SSH) client executing on the at least one first computing device to provide the access information as SSH session reauthorization information over an existing SSH connection for an existing SSH session to an SSH server executing on at least one second computing device. For example, as shown in FIGS. 1 and 2, client service(s) 112 may periodically use SSH client 114 to provide the refresh information to SSH server 144.

In step 608, the SSH server may periodically determine whether the SSH session reauthorization information is received from the SSH client within a periodic time interval. For example, as shown in FIGS. 1 and 2, SSH server 144 may determine whether refresh information is provided by SSH client 114 within a refresh period.

In step 610, the SSH server may periodically determine whether the SSH session reauthorization information received during the periodic time interval is verified or unverified. For example, as shown in FIGS. 1 and 2, SSH server 144 may receive and may execute a verification process (e.g., based on force command code) to determine whether the refresh information provided by SSH client 114 is verified or unverified.

In step 612, the SSH server may periodically maintain an SSH session if the session reauthorization information is received within the periodic time interval and is verified. For example, as shown in FIGS. 1 and 2, SSH server 144 may maintain (e.g., not terminate) the existing SSH connection/session if SSH server 144 verifies the refresh information received within the refresh period.

In step 614, terminating, by the SSH server, the SSH session if the session reauthorization information is not provided within the periodic time interval and/or is not verified. For example, as shown in FIGS. 1 and 2, SSH server 144 may terminate the existing SSH connection/session if SSH server 144 determines that refresh information was not received in the refresh period or refresh information received within the refresh period is not verified.

### III. Example Computing Device Embodiments

As noted herein, the embodiments described, along with any modules, components and/or subcomponents thereof, as well as the flowcharts/flow diagrams described herein, including portions thereof, and/or other embodiments, may be implemented in hardware, or hardware with any combination of software and/or firmware, including being implemented as computer program code configured to be executed in one or more processors and stored in a computer readable storage medium, or being implemented as hardware logic/electrical circuitry, such as being implemented together in a system-on-chip (SoC), a field programmable gate array (FPGA), and/or an application specific integrated circuit (ASIC). A SoC may include an integrated circuit chip that includes one or more of a processor (e.g., a microcontroller, microprocessor, digital signal processor (DSP), etc.), memory, one or more communication interfaces, and/or further circuits and/or embedded firmware to perform its functions.

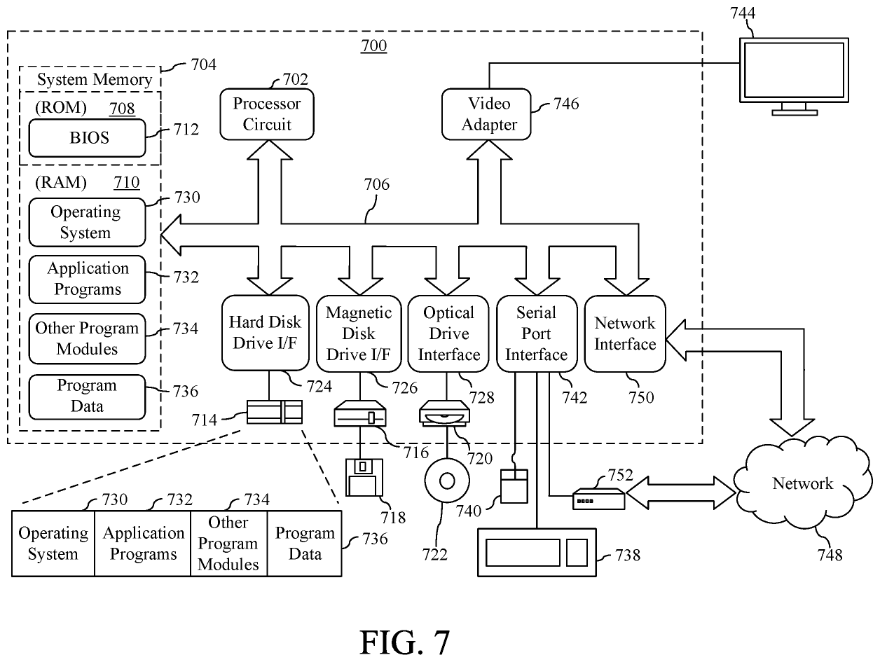

FIG. 7 shows an exemplary implementation of a computing device 700 in which example embodiments may be implemented. Consistent with all other descriptions provided herein, the description of computing device 700 is a non-limiting example for purposes of illustration. Example embodiments may be implemented in other types of computer systems, as would be known to persons skilled in the relevant art(s). Computing device 700 may comprise, for example, an implementation of any one of client computing device(s) 110, authentication computing device(s) 120, admin computing device(s) 130, server computing device(s) 140, or user computing device(s) 150 as described above in reference to FIG. 1.

As shown in FIG. 7, computing device 700 includes one or more processors, referred to as processor circuit 702, a system memory 704, and a bus 706 that couples various system components including system memory 704 to processor circuit 702. Processor circuit 702 is an electrical and/or optical circuit implemented in one or more physical hardware electrical circuit device elements and/or integrated circuit devices (semiconductor material chips or dies) as a central processing unit (CPU), a microcontroller, a microprocessor, and/or other physical hardware processor circuit. Processor circuit 702 may execute program code stored in a computer readable medium, such as program code of operating system 730, application programs 732, other programs 734, etc. Bus 706 represents one or more of any of several types of bus structures, including a memory bus or memory controller, a peripheral bus, an accelerated graphics port, and a processor or local bus using any of a variety of bus architectures. System memory 704 includes read only memory (ROM) 708 and random-access memory (RAM) 710. A basic input/output system 712 (BIOS) is stored in ROM 708.

Computing device 700 also has one or more of the following drives: a hard disk drive 714 for reading from and writing to a hard disk, a magnetic disk drive 716 for reading from or writing to a removable magnetic disk 718, and an optical disk drive 720 for reading from or writing to a removable optical disk 722 such as a CD ROM, DVD ROM, or other optical media. Hard disk drive 714, magnetic disk drive 716, and optical disk drive 720 are connected to bus 706 by a hard disk drive interface 724, a magnetic disk drive interface 726, and an optical drive interface 728, respectively. The drives and their associated computer-readable media provide nonvolatile storage of computer-readable instructions, data structures, program modules and other data for the computer. Although a hard disk, a removable magnetic disk and a removable optical disk are described, other types of hardware-based computer-readable storage media can be used to store data, such as flash memory cards, digital video disks, RAMs, ROMs, and other hardware storage media.

A number of program modules may be stored on the hard disk, magnetic disk, optical disk, ROM, or RAM. These programs include operating system 730, one or more application programs 732, other programs 734, and program data 736. Application programs 732 or other programs 734 may include, for example, computer program logic (e.g., computer program code or instructions) for implementing any of the components shown in FIGS. 1-3 (e.g., client service(s) 112, SSH client 114, authentication service 122, application(s) 132, server service(s) 142, SSH server 144, application(s) 152, private network web server 305, private network “connector” 310, or cloud tunnel server 315), any of the steps of the flowcharts depicted in FIGS. 4-6.

A user may enter commands and information into the computing device 700 through input devices such as keyboard 738 and pointing device 740. Other input devices (not shown) may include a microphone, joystick, game pad, satellite dish, scanner, a touch screen and/or touch pad, a voice recognition system to receive voice input, a gesture recognition system to receive gesture input, or the like. These and other input devices are often connected to processor circuit 702 through a serial port interface 742 that is coupled to bus 706, but may be connected by other interfaces, such as a parallel port, game port, or a universal serial bus (USB).

A display screen 744 is also connected to bus 706 via an interface, such as a video adapter 746. Display screen 744 may be external to, or incorporated in computing device 700. Display screen 744 may display information, as well as being a user interface for receiving user commands and/or other information (e.g., by touch, finger gestures, virtual keyboard, etc.). In addition to display screen 744, computing device 700 may include other peripheral output devices (not shown) such as speakers and printers.

Computing device 700 is connected to a network 748 (e.g., the Internet) through an adaptor or network interface 750, a modem 752, or other means for establishing communications over the network. Modem 752, which may be internal or external, may be connected to bus 706 via serial port interface 742, as shown in FIG. 7, or may be connected to bus 706 using another interface type, including a parallel interface.

As used herein, the terms “computer program medium,” “computer-readable medium,” and “computer-readable storage medium” are used to refer to physical hardware media such as the hard disk associated with hard disk drive 714, removable magnetic disk 718, removable optical disk 722, other physical hardware media such as RAMs, ROMs, flash memory cards, digital video disks, zip disks, MEMs, nanotechnology-based storage devices, and further types of physical/tangible hardware storage media. Such computer-readable storage media are distinguished from and non-overlapping with communication media (do not include communication media). Communication media embodies computer-readable instructions, data structures, program modules or other data in a modulated data signal such as a carrier wave. The term “modulated data signal” means a signal that has one or more of its characteristics set or changed in such a manner as to encode information in the signal. By way of example, and not limitation, communication media includes wireless media such as acoustic, RF, infrared and other wireless media, as well as wired media. Example embodiments are also directed to such communication media that are separate and non-overlapping with embodiments directed to computer-readable storage media.

As noted above, computer programs and modules (including application programs 732 and other programs 734) may be stored on the hard disk, magnetic disk, optical disk, ROM, RAM, or other hardware storage medium. Such computer programs may also be received via network interface 750, serial port interface 742, or any other interface type. Such computer programs, when executed or loaded by an application, enable computing device 700 to implement features of example embodiments described herein. Accordingly, such computer programs represent controllers of the computing device 700.

Example embodiments are also directed to computer program products comprising computer code or instructions stored on any computer-readable medium. Such computer program products include hard disk drives, optical disk drives, memory device packages, portable memory sticks, memory cards, and other types of physical storage hardware.

### IV. Further Example Embodiments

Methods, systems and computer program products are provided for service to service SSH with authentication and SSH session reauthentication. A client service may initiate an SSH session, for example, by providing authentication information (e.g., OAuth client credentials) to an authentication provider service (e.g., an OAuth provider), which may return access information (e.g., an access token) for valid credentials. The client service may use an SSH client to provide the access information to an SSH server. The SSH server may receive and validate the access information. A service-to-service SSH session may be created between the SSH client and SSH server. The client service and a server service may communicate securely via the service-to-service SSH session. Security may be maintained for any type of SSH connection (e.g., user to service, service to service), for example, by periodically and automatically providing, receiving and validating reauthentication or access information. AN SSH connection/session may be maintained if periodic reauthentication/access information is periodically provided and validated. AN SSH connection/session may be terminated if periodic reauthentication/access information is not provided in a time interval or is invalid.

In an example, a method for establishing and maintaining an SSH session may comprise, for example, establishing a secure shell (SSH) session between an SSH client and an SSH server based, at least in part, on providing, receiving or validating authentication information; and maintaining security during the SSH session based, at least in part, on providing, receiving or validating periodic reauthentication information.

In an example, the method may further comprise, for example, terminating the SSH session, at least if the reauthetication information is not periodically received or is not periodically validated.

In an example, the SSH session may be an SSH user-to-service session or a service-to-service SSH session.

In an example, the method may further comprise, for example, initiating the SSH session based, at least in part, by providing, receiving or validating a token provided by an authorization provider service; and maintaining the security during the SSH session based, at least in part, on providing, receiving or validating a token periodically provided by the authorization provider service.

In an example, a method for establishing a service-to-service SSH connection/session may comprise, for example, providing, by a first service executing on at least one first computing device, authentication information that is associated with the first service to an authentication provider service executing on at least one authentication provider computing device; receiving, by the first service, access information from the authentication provider service in response to providing the authentication information; utilizing, by the first service, an SSH client executing on the at least one first computing device to provide the access information to an SSH server executing on at least one second computing device; and utilizing, by the first service, the SSH client to send information to or receive information from a second service executing on the at least one second computing device via a service-to-service SSH session (e.g., shell or tunneling/port forwarding) established between the SSH client and the SSH server in response to at least the providing of the access information to the SSH server.

In an example, the method may further comprise, for example, registering the first service with the authentication provider service; receiving the authentication information in response to the registration; and configuring the first service to provide the authentication information to the authentication provider service to initiate the service-to-service SSH session.

In an example, an authentication provider service may comprise an OAuth endpoint. Authentication information may comprise an identifier and a secret (e.g., OAuth client credentials). Access information may comprise an access token (e.g., signed by OAuth provider, such as AAD).

In an example, the method may further comprise, for example, configuring the at least one second computing device to authenticate the first service based on the access information; verifying, by the at least one second computing device, the access information provided by the first service; and establishing the service-to-service SSH session based, at least in part, on the verification of the access information.

In an example, at least one operating system of the at least one second computing device may be configured with a username associated with the first service and a pluggable authentication module (PAM) to log in the username associated with the first service for the service-to-service SSH session by verifying the access information.

In an example, at least one first computing device may comprise at least one computing device in a private network (PN) operated by a client and wherein the at least one second computing device comprises at least one cloud computing server providing a cloud computing service subscribed to by the client.

In an example, the method may further comprise, for example, providing secure remote access to the PN for at least one remote user associated with the client from at least one computing device used by the at least one remote user through the at least one second computing device over the service-to-service SSH session to the at least one first computing device in the PN.

In an example, the method may further comprise, for example, maintaining security during the service-to-service secure shell (SSH) session by periodically: providing, by the first service, the authentication information to the authentication provider service; receiving periodic access information from the authentication provider in response to providing the authentication information; providing the periodic access information over the service-to-service SSH session; determining whether the periodic access information is verified or unverified; and maintaining the service-to-service SSH session if the periodic access information is verified.

In an example, the method may further comprise, for example, terminating the service-to-service SSH session if the periodic access information is not provided within a periodic time interval or if the periodic access information is not verified.

In an example, determining whether the periodic access information is verified or unverified comprises: running a force command that: determines whether the periodic access information is received within the periodic time interval; determines (e.g., by executing a pluggable authentication module (PAM)), if the periodic access information is received, whether the periodic access information is verified or unverified; terminates the service-to-service SSH session if the periodic access information is not provided within the periodic time interval or if the periodic access information is not verified; and maintains the service-to-service SSH session if the periodic access information is provided within the periodic time interval and the periodic access information is verified.

In an example, a method for maintaining security during an SSH session may comprise, for example, periodically: determining, by an SSH server executing on at least one second computing device, whether SSH session reauthorization information is received from an SSH client executing on at least one first computing device within a periodic time interval; determining whether the SSH session reauthorization information received during the periodic time interval is verified or unverified; maintaining the SSH session if the session reauthorization information is received within the periodic time interval and is verified; and terminating the SSH session if the session reauthorization information is not provided within the periodic time interval or is not verified.

In an example, an SSH session may be an SSH user-to-service session or a service-to-service SSH session.

In an example, the method may further comprise, for example, establishing the service-to-service SSH session by: providing, by a first service executing on the at least one first computing device, authentication information that is associated with the first service to an authentication provider service executing on at least one authentication provider computing device; receiving, by the first service, access information from the authentication provider service in response to providing the authentication information; providing the access information by the SSH client to the SSH server; and verifying, by the at least one second computing device, the access information; and establishing, by the SSH server, the service-to-service SSH session based on the verification.

In an example, the authentication provider may comprise an OAuth endpoint. Access information may comprise an access token issued by the OAuth endpoint. An (e.g., each) periodic session reauthorization information may comprise an access token issued by the OAuth endpoint.

In an example, the method may further comprise, for example, receiving, by the SSH server, the session reauthorization information over an SSH command channel.

In examples, any step(s) (e.g., methods) disclosed herein may be implemented, for example, by an apparatus, which may comprise one or more processors configured to execute computer executable instructions, which may be stored on a computer readable medium or a computer program product, that, when executed by the one or more processors, performs the method. The apparatus may, thus, comprise one or more processors configured to perform the method. The computer readable medium or the computer program product may comprise instructions that cause one or more processors to perform the method by executing the instructions.

### V. Conclusion

While various embodiments of the present invention have been described above, it should be understood that they have been presented by way of example only, and not limitation. It will be understood by those skilled in the relevant art(s) that various changes in form and details may be made therein without departing from the spirit and scope of the invention as defined in the appended claims. Accordingly, the breadth and scope of the present invention should not be limited by any of the above-described exemplary embodiments, but should be defined only in accordance with the following claims and their equivalents.

What is claimed is:

1. A method comprising:
providing, by a first service executing on at least one first computing device, authentication information that is associated with the first service to an authentication provider service executing on at least one authentication provider computing device;
receiving, by the first service, access information from the authentication provider service in response to providing the authentication information;
utilizing, by the first service, a secure shell (SSH) client executing on the at least one first computing device to provide the access information to an SSH server executing on at least one second computing device; and
utilizing, by the first service, the SSH client to send information to or receive information from a second service executing on the at least one second computing device via a service-to-service SSH session established between the SSH client and the SSH server in response to at least the providing of the access information to the SSH server.

2. The method of claim 1, further comprising:
registering the first service with the authentication provider service;
receiving the authentication information in response to the registration; and
configuring the first service to provide the authentication information to the authentication provider service to initiate the service-to-service SSH session.

3. The method of claim 1,
wherein the authentication information comprises an identifier and a secret; and
wherein the access information comprises an access token.

4. The method of claim 1, wherein the authentication provider service comprises an OAuth endpoint.

5. The method of claim 1, further comprising:
configuring the at least one second computing device to authenticate the first service based on the access information;
verifying, by the at least one second computing device, the access information provided by the first service; and
establishing the service-to-service SSH session based, at least in part, on the verification of the access information.

6. The method of claim 5, wherein at least one operating system of the at least one second computing device is configured with a username associated with the first service and a pluggable authentication module (PAM) to log in the username associated with the first service for the service-to-service SSH session by verifying the access information.

7. The method of claim 1, wherein the at least one first computing device comprises at least one computing device in a private network (PN) operated by a client and wherein the at least one second computing device comprises at least one cloud computing server providing a cloud computing service.

8. The method of claim 7, further comprising:
providing secure remote access to the PN for at least one remote user associated with the client from at least one computing device used by the at least one remote user through the at least one second computing device over the service-to-service SSH session to the at least one first computing device in the PN.

9. The method of claim 1, further comprising:
maintaining security during the service-to-service SSH session by periodically:
providing, by the first service, the authentication information to the authentication provider service;
receiving periodic access information from the authentication provider in response to providing the authentication information;
providing the periodic access information over the service-to-service SSH session;
determining whether the periodic access information is verified or unverified; and
maintaining the service-to-service SSH session if the periodic access information is verified.

10. The method of claim 9, further comprising:
terminating the service-to-service SSH session if the periodic access information is not provided within a periodic time interval or if the periodic access information is not verified.

11. The method of claim 10, wherein the determining whether the periodic access information is verified or unverified comprises:
running a force command that:
determines whether the periodic access information is received within the periodic time interval;
determines whether the periodic access information is verified or unverified;
terminates the service-to-service SSH session if the periodic access information is not provided within the periodic time interval or if the periodic access information is not verified; and
maintains the service-to-service SSH session if the periodic access information is provided within the periodic time interval and the periodic access information is verified.

12. A method comprising:
maintaining security during a secure shell (SSH) session by periodically:
determining, by an SSH server executing on at least one second computing device, whether SSH session reauthorization information is received from an SSH client executing on at least one first computing device within a periodic time interval;
determining whether the SSH session reauthorization information received during the periodic time interval is verified or unverified;
maintaining the SSH session if the session reauthorization information is received within the periodic time interval and is verified; and
terminating the SSH session if the session reauthorization information is not provided within the periodic time interval or is not verified.

13. The method of claim 12, wherein the SSH session is a service-to-service SSH session.

14. The method of claim 13, further comprising:
establishing the service-to-service SSH session by:
providing, by a first service executing on the at least one first computing device, authentication information that is associated with the first service to an authentication provider service executing on at least one authentication provider computing device;
receiving, by the first service, access information from the authentication provider service in response to providing the authentication information;
providing the access information by the SSH client to the SSH server; and
verifying, by the at least one second computing device, the access information; and
establishing, by the SSH server, the service-to-service SSH session based on the verification.

15. The method of claim 14,
wherein the authentication provider comprises an OAuth endpoint;
wherein the access information comprises an access token issued by the OAuth endpoint; and
wherein each periodic session reauthorization information comprises an access token issued by the OAuth endpoint.

16. The method of claim 12, further comprising:
receiving, by the SSH server, the session reauthorization information over an SSH command channel.

17. A method comprising:
initiating a secure shell (SSH) session between an SSH client and an SSH server based, at least in part, on providing, receiving or validating authentication information; and
maintaining security during the SSH session based, at least in part, on providing, receiving or validating periodic reauthentication information.

18. The method of claim 17, further comprising:
terminating the SSH session, at least if the reauthetication information is not periodically received or is not periodically validated.

19. The method of claim 17, wherein the SSH session is a service-to-service SSH session.

20. The method of claim 17, further comprising:
initiating the SSH session based, at least in part, by providing, receiving or validating a token provided by an authorization provider service; and
maintaining the security during the SSH session based, at least in part, on providing, receiving or validating a token periodically provided by the authorization provider service.
